(19) United States
(12) Patent Application Publication
(10) Pub. No.: US 2008/0149789 A1
(43) Pub. Date: Jun. 26, 2008

(54) Motorized mounting system capable of repositioning a monitor

(76) Inventors: Byung J. Yi, Buchon City (KR); Gyu Chang Kim, Suwon Si (KR)

Correspondence Address: SUNG I. OH, PROFESSIONAL LAW CORPORATION, 710 QUAIL VALLEY LANE, WEST COVINA, CA, 91791, US

(21) Appl. No.: 11/810,109

(22) Filed: Jun. 4, 2007

Related U.S. Application Data
(60) Provisional application No. 60/810,581, filed on Jun. 2, 2006.

(51) Int. Cl. F16M 11/00

(52) U.S. Cl. 248/176.1

(57) ABSTRACT

A motorized mounting system includes a first portion and a second portion where the first portion is adapted to attach to a mounting surface such as a ceiling or wall, and the second portion is adapted to couple to the back side of a monitor such as a plasma or LCD TV. The second portion has a hinge bracket that attaches to the back side of the monitor. The hinge bracket is mechanically couple to a first motor where activation of the first motor causes the hinge bracket to tilt the monitor. The second portion is mechanically coupled to a second motor where activation of the second motor causes the second portion to swivel relative to the first portion. The motorized mounting system can be controlled by a remote control the tilt and swivel the monitor.

### RELATED APPLICATIONS

This application claims priority to a U.S. Provisional Patent Application Ser. No. 60/810,581, which was filed Jun. 2, 2006.

### BACKGROUND OF THE INVENTION

1. Field of the Invention

This invention is directed to a motorized mounting system that is adapted to couple to a back side of a monitor and reposition the viewing angle of the monitor remotely.

2. Background of the Invention

Flat panel monitors such as computer monitors, LCD, plasma, slim televisions, and the like (collectively referred to as “monitor(s)”) are becoming popular because they can be mounted onto a wall to save floor space and for their aesthetically pleasing appearance. In many applications, the monitor is placed on a table, mounted to a wall, or even hanging from a ceiling. In these applications, however, in order to reposition the monitor, the viewer needs to walk over to the monitor and physically move the monitor to a new viewing angle. Repositioning a monitor, however, is not always feasible because of the weight of the monitor makes it difficult to move or the monitor may be located high above the floor so that the viewer may not be able to reach it without a ladder for example. Accordingly, there is a need to be able to reposition the monitor more easily.

### INVENTION SUMMARY

This invention is directed to a motorized mounting system including a first portion and a second portion where the first portion is adapted to attach to a mounting surface such as a ceiling or wall, and the second portion is adapted to couple to the back side of a monitor such as a plasma or LCD TV. The second portion has a hinge bracket that attaches to the back side of the monitor. The hinge bracket is mechanically couple to a first motor where activation of the first motor causes the hinge bracket to tilt the monitor. The second portion is mechanically coupled to a second motor where activation of the second motor causes the second portion to swivel relative to the first portion. The motorized mounting system can be controlled by a remote control the tilt and swivel the monitor.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a motorized mounting system.

FIG. 2 is a perspective view of the motorized mounting system of FIG. 1 in a disassembled state.

FIG. 3 is a front cross-sectional view of the motorized mounting system.

FIG. 4 is a block diagram of the motorized mounting system in communication with a remote control.

FIG. 5 is a side cross-sectional view of the motorized mounting system.

FIG. 6 is a top cross-sectional view of the motorized mounting system.

### DETAILED DESCRIPTION OF THE INVENTION

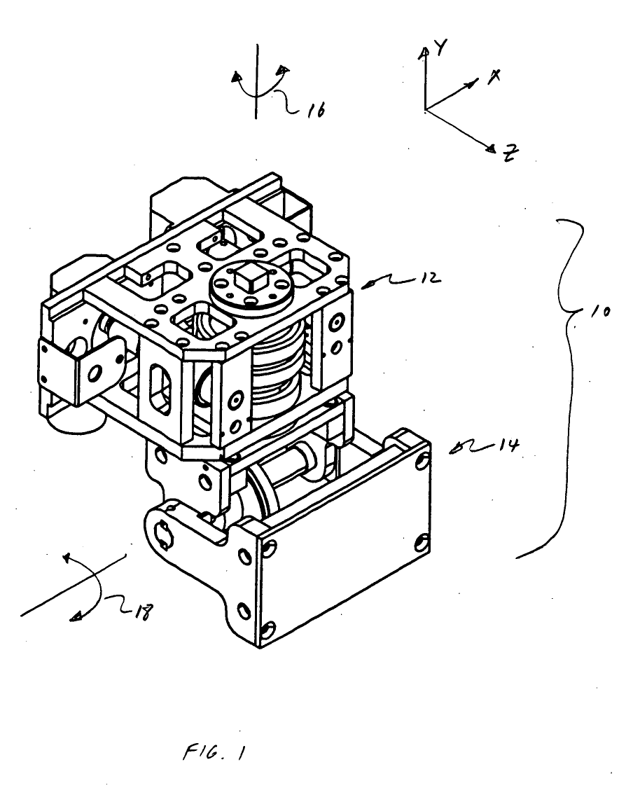

FIG. 1 shows a perspective view of a motorized mounting system 10 having a first portion 12 and a second portion 14 in reference to X, Y, and Z coordinates. The first portion 12 may be adapted to couple to a supporting structure such as a wall, ceiling, and stand, table, etc. The second portion 14 may be adapted to swivel and/or tilt relative to the first portion 12. For purpose of this discussion, a swivel movement 16 is generally defined as the second portion 14 moving substantially along the XZ plane or around the Y-axis; and a tilt movement 18 is generally defined as the second portion 14 moving substantially along the YZ plane or around the X-axis.

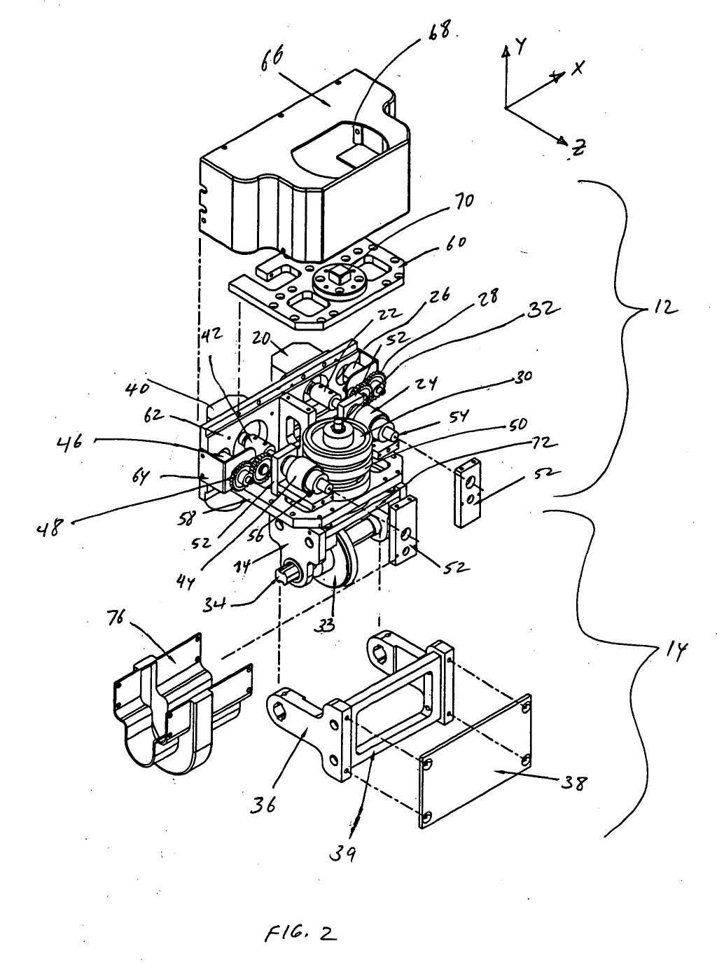

FIG. 2 is an exploded view of the motorized mounting system 100. The first portion 12 of the system 10 includes a first motor 20 coupled to a first flexible coupling 22 that in turn may be coupled to a first worm gear 24. The first flexible coupling 22 compensates for the misalignment between the two shafts of the first motor 20 and the first worm gear 22. A first position sensor 26 may be engaged with the first worm gear 24 through the gear mechanisms 28. The first position sensor 26 may keep track of the movement of the first worm gear 24. A variety of position sensors may be used such as hall-effect or variable-reluctance (VR) speed sensors. The first worm gear 24 may be rotationally engaged with a first worm wheel 30 such that rotation of the first worm gear 24 rotates the first worm wheel 30. The first worm wheel 30 may be coupled to a shaft 32 such that rotation of the first worm wheel 30 causes the shaft 32 to rotate as well.

As further discussed below, the shaft 32 may couple the first portion 12 and the second portion 14 together such that the two portions 12 and 14 may rotate or swivel relative to each other. The shaft 32 may be mechanically coupled to a first bevel gear 33 that extends to form an axle 34. The first bevel gear 33 and the axle 34 may be located in the second portion 14 of the system 10 such that rotation of the shaft 32 along the Y-axis causes the first bevel gear to rotate which in turn causes the axle 34 to rotate about the X-axis. The axle 34 may be coupled to a hinge bracket 36, which may be adapted to couple to a mounting plate 38. The mounting plate 38 may be adapted to couple to a back side of a monitor (not shown). The hinge bracket 36 has a mounting face 39 adapted to couple to the mounting plate 38. Accordingly, as the first motor 20 rotates the first worm gear 24, the axle 34 rotates as well to tilt the hinge bracket 36, thereby tilting the monitor attached to the mounting plate 38.

The first portion 12 of the system 10 also includes a second motor 40 coupled to a second flexible coupling 42 that in turn may be coupled to a second worm gear 44. The second flexible coupling 42 compensates for the misalignment between the two shafts of the second motor 40 and the second worm gear 44. A second position sensor 46 may be engaged with the second worm gear 40 through the gear mechanisms 48. The second position sensor 46 may keep track of the movement of the second worm gear 44. The second worm gear 44 may be rotationally engaged with a second worm wheel 50 such that rotation of the second worm gear 44 rotates the second worm wheel 50.

The second worm wheel 50 may freely rotate relative to the first worm wheel 30 such that rotation of the first worm wheel 30 does not cause the second worm wheel 50 to rotate. The second worm wheel 50 may be mechanically coupled to the second portion 14 such that rotation of the second worm wheel 50 causes the second portion 14 to swivel about the Y axis. Accordingly, as the second motor 40 rotates the second worm gear 44, the second portion 14 swivels to swivel the monitor attached to the mounting plate 38.

FIG. 2 also shows that each of the worm gears 24 and 44 are supported by brackets 52 along their respective longitudinal axes 54 and 56. The mechanisms within the first portion 12 are partially enclosed by a first base plate 58, a cover plate 60, and a motor support plate 62. Each of the two position sensors 26 and 46 is supported by an L-shaped bracket 64. The first portion 12 may be enclosed by a first housing 66 with an opening 68. The cover plate 60 may have an anchor 70 to attach the motorized mounting system to a support structure such as a wall, ceiling, TV stand or table. The anchor 70 may be exposed through the opening 68 for coupling to the support structure.

FIG. 2 also shows that the second portion 14 has a second base plate 72 between two legs 74. The two legs support the first bevel gear 33 and the axle 34. The second portion 14 may include a second housing 76 to substantially enclose the second portion.

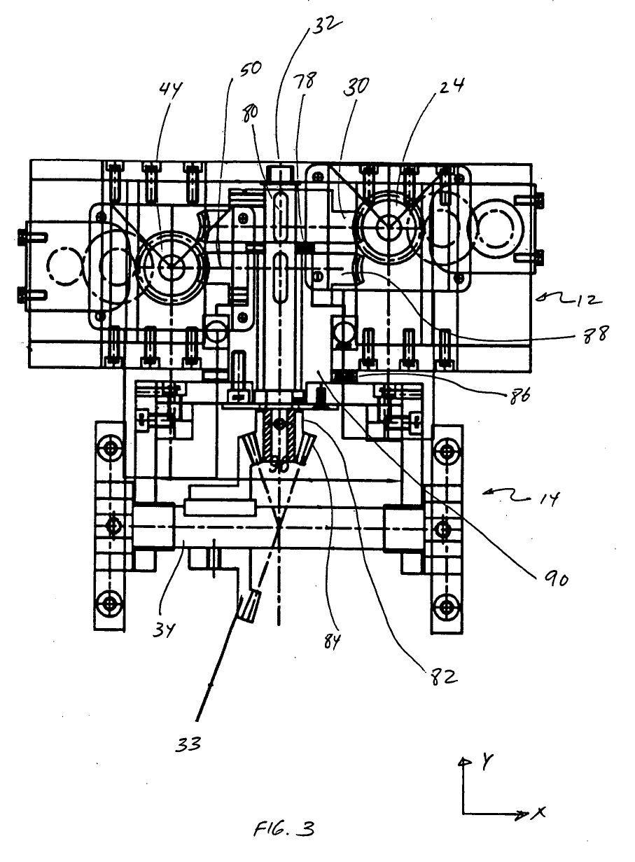

FIG. 3 is a cross-sectional view of the motorized mounting system 10 along the XY plane. FIG. 3 shows the first worm gear 24 engaged with the first worm wheel 30, and the second worm gear 44 engaged with the second worm wheel 50. A first bearing 78 may be provided between the first and second worm wheels 30 and 50 so that they may freely rotate relative to each other. In addition, the shaft 32 passes through the second worm wheel 50 such that the shaft 32 freely rotates within the second worm wheel 50. The shaft 32 has a proximal end 80 and a distal end 82. The proximal end 80 of the shaft is coupled to the first worm wheel 30 and the distal end 82 may be coupled to a second bevel gear 84. The first and second bevel gears 33 and 82 are engaged with each other such that rotation of the second bevel gear 84 causes the first bevel gear 33 to rotate which in turn causes the axle 34 to tilt the monitor.

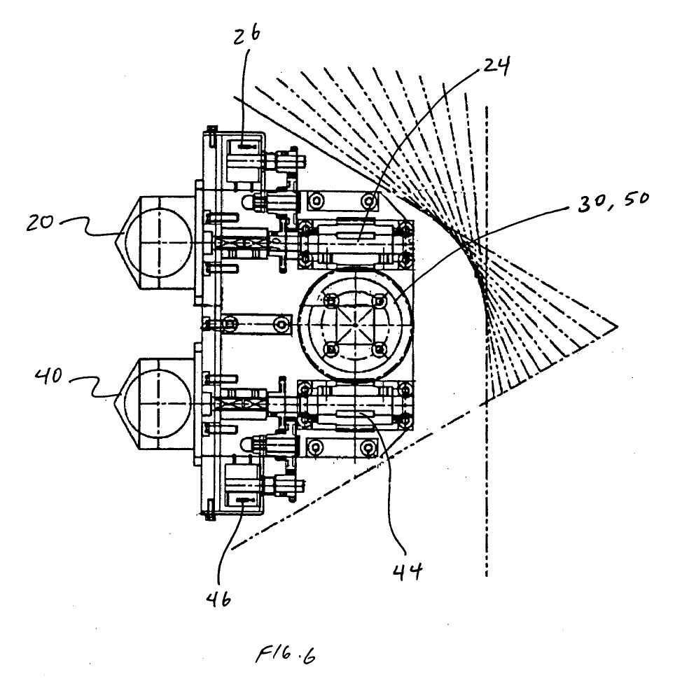

FIGS. 3, 5, and 6 show a second bearing 86 between the first portion 12 and the second portion 14 to allow the second portion 14 to swivel relative to the first portion 14. The second worm wheel 50 has a proximal end 88 and a distal end 90. The proximal end 88 is adapted to engage with the second worm gear 44 and the distal end 90 is coupled to the second portion. As the second worm gear 44 rotates, the proximal end 88 and the distal end 90 of the second worm wheel rotates as well, which in turn rotates or swivels the second portion 14. The second worm wheel 50 rotates freely relative to the shaft 32; however, as the second portion 14 swivels, the first bevel gear 33 rotates relative to the second bevel gear 82 that is stationary. This means that rotation of the first bevel gear 33 rotates the axle 34, which causes the axle 34 to tilt the monitor. Accordingly, in applications where only the swivel movement is desired, the motorized mounting system 10 needs to account for the undesired tilting of the monitor due to the second motor 40 swiveling the monitor.

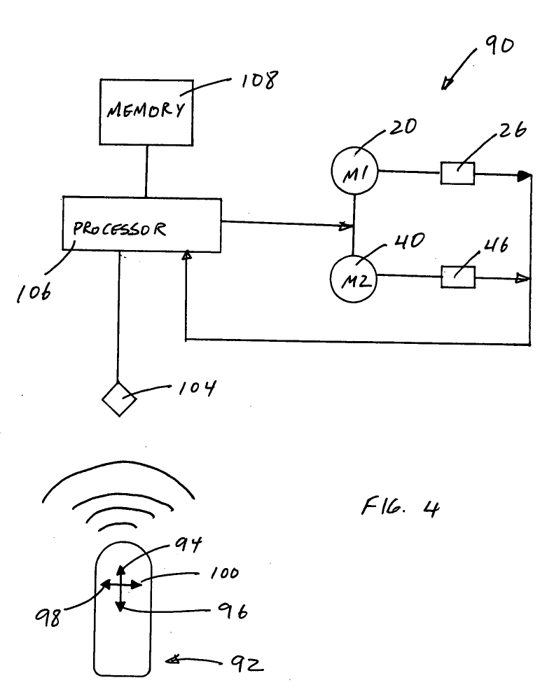

FIG. 4 shows a block diagram 90 illustrating the control process for the motorized mounting system 10. A remote control 92 may be used to have the motorized mounting system 10 tilt and/or swivel the monitor. The remote control has up and down tilt buttons 94 and 96, and swivel left and swivel right buttons 98 and 100. The remote control 92 may send a control signal 102 to a receiver 104 that is communicably coupled to a processor 106. Depending on the control signal 102, the processor 106 may control the current or power provided to the first and second motors 20 and 40 to respond to the control signal accordingly. The first and second position sensors 26 and 46 may provide feedback information to the processor 106 to indicate the positioning of the first and second worm wheels 30 and 50, respectively, so that the viewing angle of the monitor may be tracked. The feedback information from the two position sensors 26 and 46 may be stored in a memory 108.

As discussed above, as the second portion 14 swivels, the first bevel gear 33 rotates relative to the second bevel gear 82 (shown FIG. 3), which rotates the axle 34 to tilt the monitor. In situations where only the swivel movement is desired, such as when either swivel buttons 98 or 100 is activated, the processor 106 may activate the second motor 40, as discussed above, to swivel the second portion 14, and also activate the first motor 20 to counter-rotate the second bevel gear 84 relative to the first bevel gear 33 so that the axle 34 maintains its tilt position as the second portion 14 swivels. During the swivel movement, the processor 106 may counter-rotate the second bevel gear 84 based on the feedback information provided by the position sensor 26 stored in the memory 108 to maintain the initial tilt position prior to the swivel movement.

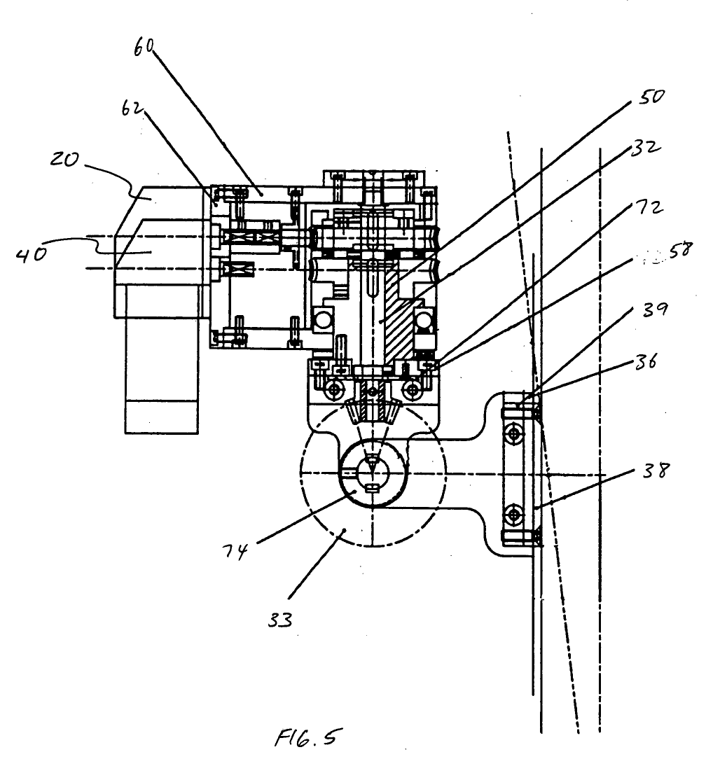

If a user activates either up or down buttons 94 or 96, then the processor 106 may active the first motor 20 to tilt the monitor, as discussed above. FIG. 5 shows a side view of a partial cutout view of the motorized mounting system 10.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A motorized mounting system adapted to reposition a monitor, the motorized mounting system comprising:
a first motor (20);
a second motor (40);
a first portion (12) having the first motor (20) and the second motor (40);
a first bevel gear (33);
a second portion (40) having the first bevel gear (33), the second portion (40) coupled to the second motor (40) such that activation of the second motor (40) causes the second portion (14) to swivel relative to the first portion (12);
a shaft (32) coupling the first portion (12) and second portion (14) such that the second portion (14) is able to swivel relative to the first portion (12), the shaft (32) having a proximal end (80) and a distal end (82), the proximal end (80) of the shaft (32) coupled to the first motor (20), and the distal end (82) of the shaft (32) coupled to the first bevel gear (33); and
a hinge bracket (36) having a proximal end and a distal end, the proximal end of the hinge bracket coupled to the first bevel gear (33), the distal end of the hinge bracket adapted to couple to a monitor, where activation of the first motor (20) causes the hinge bracket (36) to tilt up and down.

2. The motorized mounting system according to claim 1, including a processor (106) to activate the first motor (20) to swivel the second portion (14) relative to the first portion (12) and to active the second motor (40) to tilt the hinge bracket (36).

3. The motorized mounting system according to claim 2, including a remote control (92) adapted to transmit a control signal (102) to the processor (106) to control the first and second motors (20, 40).

4. The motorized mounting system according to claim 1, where the processor (106) activates the second motor (40) to substantially swivel the second portion (14) relative to the first portion (12) without tilting the hinge bracket (36) by activating the first motor (20) to counter rotate the distal end (82) of the shaft (32).

5. A motorized mounting system adapted to reposition a monitor having a back side, the motorized mounting system comprising:
a first portion;
a second portion adapted to swivel relative to the first portion;
a hinge bracket having a proximal end and a distal end, the distal end adapted to couple to the back side of the monitor, and the proximal end adapted to tilt relative to the second portion,
a first motor mechanically coupled to the proximal end of the hinge bracket to tilt the proximal end of the hinge bracket; and
a second motor mechanically coupled to the second portion to swivel the second portion relative to the first portion.

6. The motorized mounting system according to claim 5, including a shaft coupling the first and second portions such that the second portion (14) is able to swivel relative to the first portion (12), the shaft (32) having a proximal end (80) and a distal end (82), the proximal end (80) of the shaft (32) mechanically engaged with the first motor (20), and the distal end (82) of the shaft (32) mechanically engaged with a first bevel gear (33), the proximal end of the hinge bracket coupled to the first bevel gear (33) such that activation of the first motor (20) causes the hinge bracket (36) to tilt up and down.

7. The motorized mounting system according to claim 5, including a first worm wheel mechanically coupling the first motor to the distal end of the shaft such that activation of the first motor causes the first worm wheel to rotate the shaft to rotate the first bevel gear to tilt the proximal end of the hinge bracket.

8. The motorized mounting system according to claim 7, including a second worm wheel mechanically coupling the second motor to the second portion such that activation of the second motor cause the second worm wheel to swivel the second portion relative to the first portion.
